(19) United States
(12) Patent Application Publication
(10) Pub. No.: US 2015/0050125 A1
(43) Pub. Date: Feb. 19, 2015

(54) FLUID SEAL ARRANGEMENT AND METHOD FOR CONSTRICTING A LEAKAGE FLOW THROUGH A LEAKAGE GAP

(71) Applicant: ALSTOM Technology Ltd, Baden (CH)

(72) Inventors: Carlos SIMON-DELGADO, Baden (CH); Vasileios STEFANIS, Niederrohrdorf (CH); Sergey SHCHUKIN, Mellingen (CH); Joerg KRUECKELS, Birmenstorf (CH)

(21) Appl. No.: 14/341,264

(22) Filed: Jul. 25, 2014

(30) Foreign Application Priority Data
Aug. 14, 2013 (EP) 13180392.6

(51) Int. Cl. F01D 11/10; F16J 15/40

(52) U.S. Cl. CPC F01D 11/10; F16J 15/40
USPC 415/110; 277/431; 277/304

(57) ABSTRACT

The invention refers to a fluid seal arrangement for constricting a leakage flow directed through a leakage gap bordered by a rotational and a stationary component including at least one nozzle opening in the rotating and/or stationary component facing towards the rotating or stationary component of an opposite side of the leakage gap respectively in order for injecting a liquid or gaseous fluid flow through the nozzle opening into the leakage gap. The at least one nozzle opening is fluidly connected to a cooling channel inside said rotating and/or stationary component, so that said fluid flow emanating at the nozzle opening consists of a cooling fluid of the rotating and/or stationary component exclusively.

### CROSS-REFERENCE TO RELATED APPLICATIONS

This application claims priority to European application 13180392.6 filed Aug. 14, 2013, the contents of which are hereby incorporated in its entirety.

### TECHNICAL FIELD

The present invention relates to a fluid seal arrangement for constricting a leakage flow directed through a leakage gap bordered by a rotational and a stationary component comprising at least one nozzle opening in the rotating and/or stationary component facing towards the rotating or stationary component of an opposite side of the leakage gap respectively in order for injecting a liquid or gaseous fluid flow through the nozzle opening into the leakage gap. Such leakage flow typically occurs in rotary flow machineries like in gas turbine arrangements especially in the compressor and turbine unit thereof, in which rotating parts encloses gaps with stationary components of the units through which a small portion of the axial flow of compressed air or hat gases the units can pass without any precaution. Further a method is disclosed for constricting a leakage flow through a leakage gap bordered by a rotational and a stationary component by injecting a liquid or gaseous fluid flow into the leakage gap with a direction of flow being transversely to the direction of flow of the leakage flow.

### BACKGROUND

The document U.S. Pat. No. 7,238,001 B2 discloses a seal arrangement used in a rotary machine preferably in a gas turbine engine in which a flow of hot gases passing through the turbine stage axially performing expansion work for accelerating the momentum of rotation of the rotor. To avoid leakage flow through gaps which are bordered radially between rotating and stationary components of the turbine especially said leakage flow does not contribute to energy generation well known techniques are used to reduce the clearance of the gap for example by applying labyrinth-sealing structures between rotating and stationary components.

Labyrinth-sealing provides radially interdigitating structures which prevent an axially free flow path through the gap by applying mechanical flow obstructions with a radially extension between the gap.

Alternatively or in combination with the before mentioned labyrinth-sealing U.S. Pat. No. 7,238,001 B2 proposes the injection of a fluid flow into the leakage gap with a direction of flow being oriented transversely to the direction of the leakage flow so that the leakage flow will be constricted by the injected fluid flow fluid dynamically purely. Hereto a slot is provided in the rotating or stationary component each bordering the leakage gap through which fluid flow is injected and directed across the leakage gap in order to present a fluid flow to further constrict the available leakage gap as an effective standing fluid sheet there across.

### SUMMARY

It is an object of the invention to provide an enhanced fluid seal arrangement for constricting a leakage flow directed through a leakage gap bordered by a rotational and a stationary component based on the before disclosed principle, i. e. using a flow dynamically generated flow obstruction within the leakage gap, such that the efficiency of the rotary machine shall be enhances significantly.

The object is achieved by the sum total of the features of claim 1 or claim 2. matter of each of the claims 9 and 10 is a method for constricting a leakage flow through a leakage gap bordered by a rotational and a stationary component. The invention can be modified advantageously by the features disclosed in the sub claims as well in the following description especially referring to preferred embodiments.

For achieving an enhanced operation of a rotary flow machine it is a matter fact to eliminate any loss mechanisms involved in the flow path through a rotary flow machine, especially to avoid also any leakage flow between rotational and stationary components bordering a leakage gap. To realize the leakage flow suppression it is inventively proposed to take advantage of synergies which help to reduce the energy expenditure to establish a fluid flow for constricting the available leakage gap as an effective standing fluid sheet across the leakage gap.

According to the invention a fluid seal arrangement for constricting a leakage flow directed through a leakage gap bordered by a rotational and a stationary component comprising at least one nozzle opening in the rotating and/or stationary component facing towards the rotating or stationary component of an opposite side of the leakage gap respectively in order for injecting a liquid or gaseous fluid flow through the nozzle opening into the leakage gap is inventively improved by connecting the at least one nozzle opening fluidly to a cooling channel inside the rotating and/or stationary component, so that that fluid flow emanating at the nozzle opening consists of a cooling fluid of the rotating and/or stationary component exclusively.

The inventive fluid seal arrangement uses the cooling medium of the already existing cooling system being integrated in the rotary and/or stationary components of a rotary flow machine for example in a compressor or turbine unit a gas turbine arrangement. To avoid overheating of vanes and blades in a hot flow path of a turbine stage unit a complex system of cooling channels is inside each vane and blade through which a cooling medium passes, preferably from of compressed air taken from a section of the compressor unit. Said cooling air may cool the components in way of convective and/or impingement cooling, depending on the structural design of the cooling channels.

After performing the cooling task the cooling medium flows through the outlet opening of the cooling channels into the main channel of the rotary flow machine. It is inventively proposed to use at least a part of the cooling medium by bypassing an amount of cooling medium close upstream to the outlet opening of the cooling channel into a so called feed channel merging at the nozzle opening for injecting into the leakage gap. The technical advantage of the invention is the fact that necessary sealing fluid flow for sealing purpose is already available from previous application, i. e. from the cooling system inside the rotational and/or stationary components and therefore it is not necessary to provide any extra supply of fluid flow injecting into the leakage gap. Any direct supply lines for example from a section of the compressor unit for feeding a fluid flow to the at least one nozzle opening aren't necessary anymore rather cooling medium is available in all heat exposed components inside a rotary flow machine so that it is easily possible to tap a cooling channel of a rotary or stationary component close to the outlet opening through which cooling medium leaves into the main channel of the rotary flow machine.

A second inventive aspect which can be combined with the before described principle of reuse of cooling medium as a fluid flow for injecting through the opening into the leakage gap to fill up the leakage gap in a manner of a blockage for the leakage flow, but which can be regarded as an independent invention idea also concerns the use of the energy flow of the liquid or gaseous fluid flow injected through the nozzle opening into the leakage gap acting on to rotating or stationary component being opposite of the leakage gap to the nozzle opening. The second inventive idea uses the flow pulse which acts onto the rotating or stationary component onto which the fluid flow impacts after injecting through the nozzle opening into the leakage gap. The flow pulse can be used for enhancing or decreasing the momentum of rotation of the rotating component.

The fluid seal arrangement for constricting a leakage flow directed through a leakage gap bordered by a rotational and a stationary component comprising at least one nozzle opening in the direction and/or stationary component facing towards the rotating and stationary component of an opposite side of the leakage gap respectively in order for injecting a liquid or gaseous fluid flow through the nozzle opening into the leakage gap is inventively improved by arranging at least one nozzle opening with a nozzle axis along which the fluid flow is directed such that the nozzle axis is tilted relative to a radial direction of an axis of rotation of the rotational component such that a momentum of rotation of the rotating component is enhanced or decreased by the fluid flow in emanating the at least one nozzle opening and impacting on the rotating or stationary component be in opposite of the leakage gap to the nozzle opening.

In contrast to the known arrangement according to U.S. Pat. No. 7,238,001 B2, in which the fluid flow direction is directed radially in a plane which crosses the axis of rotation of the rotationally component orthogonally, the direction of the fluid flow injecting through that least one nozzle opening encloses an angle α≠0° with the radial direction relative to the before defined plane, i. e. in a view projection parallel to the axis of rotation of the rotational component or a plane which crosses the axis of rotation orthogonally.

By suitable choice of the inclination of the nozzle axis in or opposite to the rotational direction of the rotational component the impact of the fluid flow onto the rotational or stationary component can enhance or decrease the momentum of rotation.

In one preferred embodiment the at least one nozzle opening is arranged at the stationary component with a nozzle axis including an angle a which shall apply basically 0°<α<±90° preferably ±5°≦α≦±50°, with a radial direction the nozzle opening such that the nozzle axis is inclined in or opposite to the rotational direction of the rotational component. In case of an inclination in the rotational direction of the rotational component the fluid flow impact onto the rotational component enhances the moment of rotation. In case of an inclination the nozzle axis opposite to the rotational direction of the rotational component the momentum of rotation will decrease. It is a matter of fact that the main aspect is enhance the momentum of rotation but the scope of the invention shall cover also the possibility of decreasing the momentum of rotation.

In a further preferred embodiment the at least one nozzle opening is arranged at the rotational component with a nozzle axis including in angle β≠0° with a radial direction crossing the nozzle opening such that the nozzle axis is inclined in or against the rotational direction of the rotational component. The arrangement of the at least one nozzle opening at the rotational component can also be combined with the before described arrangement placing the at least one nozzle opening at the stationary component. In both cases the choice of the amount of inclination of the nozzle axis determines the amount of influence on the momentum of rotation and the orientation of inclination determines the type of influence, i. e. whether the momentum of rotation will be enhanced or decreased.

In case of a combined realization of nozzle openings at the rotational and stationary components the orientation of the nozzle axis can be chosen independently from each which means α≠β but preferably α and β are equal and have the same orientation.

One further embodiment is conceivable which provides at least one nozzle opening at the rotating component having a nozzle axis such that the momentum of the rotation will be enhanced. Further the stationary component also provides least one nozzle opening having a nozzle axis in opposite orientation for decreasing the momentum of rotation. The supply of fluid flow through each openings can be controlled independently so that in a first operating mode the nozzle opening at the rotating component will be supplied with fluid flow for enhancing the momentum of rotation while the fluid flow supply for that least one nozzle opening at the stationary component is suppressed. In a second operating mode the fluid flow will be injected by the nozzle opening at the stationary component to decrease the momentum of rotation while the supply of fluid flow at the nozzle openings on the rotational component is suppressed.

The inventive idea is apply able basically to all rotational flow machines but preferably to a compressor and a turbine stage of a gas turbine arrangement. Typically the rotational components of such rotational flow machines concern blades or sections of a surface of a rotor. The stationary components concern the housing or a component connected to the housing directly or indirectly, preferably a vane, a heat shield element or a combustor liner which borders the turbine housing axially. In all these cases cooling channels are integrated in heat exposed components typically so that there will be no additionally effort to use cooling air for constricting the leakage flow through leakage gaps.

Generally the proposed reused of cooling air can be applied in a rotary flow machine at any location at which a gap occurs between rotating and stationary components and of which at least one component is cooled in the before mentioned manner. Preferred embodiments will be described in more detail in combinations with the following figures.

Further a method is described for constricting a leakage flow through a leakage gap bordered by rotational and a stationary component by injecting a liquid or gaseous fluid flow into the leakage gap with a direction of flow being transversely the direction of flow of the leakage flow which inventively is characterized in that the liquid or gaseous fluid flow serves as a cooling medium for cooling the rotational and/or a stationary component first before passing the leakage gap.

The inventive method takes advantage of the use of already existing resources, i. e. the reuse of cooling air which first is fed through cooling channels inside heat exposed rotational and/or stationary components inside a rotary flow machine, before entering the leakage gap for constricting purpose of the leakage flow through the leakage gap.

A further inventive aspect is that the liquid or gaseous fluid flow will be directed into the leakage gap such that a momentum of rotation of the rotational component is enhanced or reduced by an impact of the liquid or gaseous fluid flow with the rotational and/or stationary component.

Further details of the inventive method can be derived from the following disclosure describing preferred embodiments shown in the figures.

### BRIEF DESCRIPTION OF THE DRAWINGS

The invention shall subsequently be explained in more detail based on exemplary embodiments in conjunction with the drawing. In the drawing

FIG. 1a, b shows schematically a longitudinal section through the inner diameter platform of a blade enclosing a rim cavity with the outer diameter platform of a vane and a cross sectional view through section A-A,

FIG. 2a shows schematically a longitudinal section through the platform of a blade and the platform of a vane bordering a leakage gap with impingement cooling of the platform of the vane,

FIG. 2b shows schematically a longitudinal section of a blade with cooling channel for convective cooling the blade and a neighboring vane bordering a leakage gap,

FIG. 2c shows a schematically longitudinal section through a tip of a blade and a heat shield element bordering a leakage gap.

### DETAILED DESCRIPTION

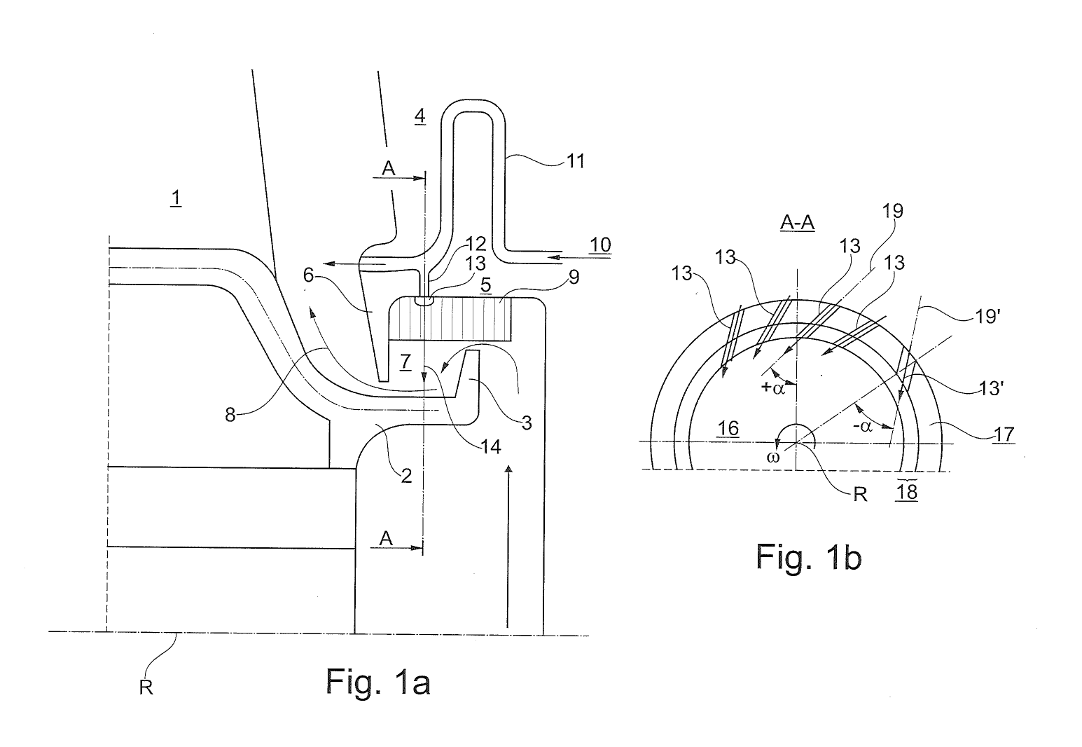

FIG. 1a shows a longitudinal section view of a rotating blade 1 around an axis of rotation R. The blade 1 comprises an inner diameter platform 2 with a knife-edge rim 3. Further a vane 4 is arranged in axial direction next to the blade 1 which is a stationary component and provides at its outer diameter also a platform 5 having a knife-edge rim 6 which borders together with the knife-edge rim 3 of the blade 1 a rim cavity 7. To reduce leakage flow 8 passing through the rim cavity 7 a honeycomb-structure 9 is attached at the platform 5 of the vane 4 for reducing the gap between platform 5 and the tip of the knife-edged rim 3 of the blade.

Due to abrasive effects on the honeycomb-structure 9 which occur during operation a leakage flow 8 passing through the rim cavity 7 is unavoidable. To reduce or restrict the leakage flow 8 partially or in a preferred manner completely it is inventively proposed to branch off a part of cooling air 10 which is fed through a cooling channel 11 inside the vane 4 into a feed line 12 which opens at a nozzle opening 13 to inject a part of the cooling air 10 as a fluid flow 14 having a flow direction transversely to the leakage flow 8 passing the rim cavity 7.

The fluid flow 14 which is injected into the rim cavity 7 constricts significantly the leakage flow 8 and acts like a fluid dynamical volumetric blockage inside the rim cavity 7.

FIG. 1a discloses the use of cooling air 10 which is fed through a cooling channel 11 and which leaves the cooling channel 11 at an opening 15 into the flow path of the flow rotary machine mainly. At least a part of the cooling air 10 will be used to establish a fluid blockage within the rim cavity 7.

FIG. 1b shows a cross section along the cut line A-A in FIG. 1a. The rotational component 16 which corresponds to the blade 1 and it's platform 2 rotates around the axis of rotation R with an orientation of rotation in anticlockwise direction. A stationary component 17, which corresponds to the vane 4 encircles the rotational component 16 enclosing a leakage gap 18, which corresponds to the rim cavity 7. To reduce leakage flow through the leakage gap 18 a multitude of nozzle openings 13 is arranged at the stationary component 17. Each of the nozzle opening 13 provides a nozzle axis 19 along which a fluid flow 14 emanates through each of the nozzle openings 13. The nozzle axis 19 encloses an angle +a with the radial direction 20 relative to the axis of rotation R. In case of the nozzle openings 13 the nozzle axis 19 is directed such that fluid flow 14 which impacts on the rotational component 16 enhances the momentum of rotation of the rotational component 16. In this case the nozzle axis is inclined in direction of rotation of the rotational component. To optimize enhancement of the momentum of rotation the angle a shall be within the angle range of 5°≦α≦50°.

Further FIG. 1b shows another possibility of arrangement of a nozzle opening 13′ having a nozzle axis 19′ which is inclined against the direction of rotation of the rotational component 16. By injecting a fluid flow through the nozzle opening 13′ the fluid flow acts onto the rotational component such that the momentum of rotation will be decreased. Therefore the angle α is of negative value and can be within the angle range −5°≦α≦−50° depending on the amount of decelerating effect on the momentum of rotation of the rotating component 16.

Both illustrated cases, i.e. the nozzle arrangement at the rotating or stationary side, can be applied depending on individual situations of operations of a rotational flow machine as well in combination or alternatively.

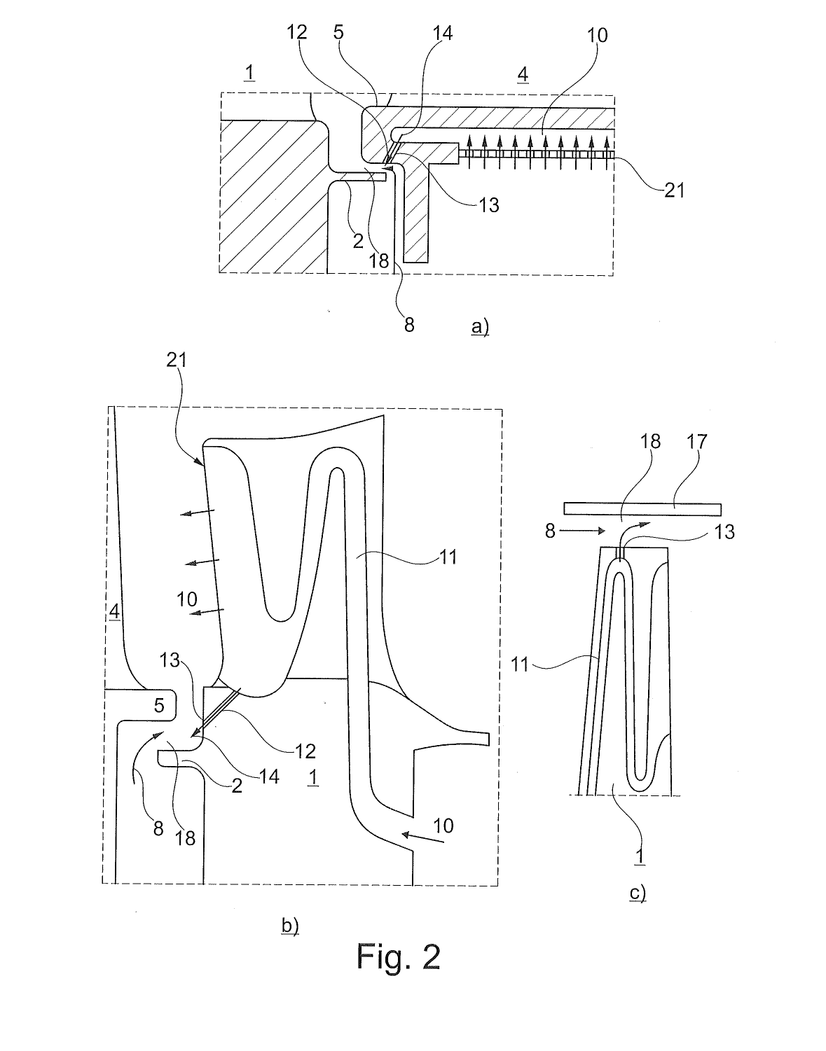

FIG. 2a shows another embodiment in longitudinal section view. Here the rotating blade 1 provides an inner diameter platform 2 which borders a leakage gap 18 with the platform 5 of a vane 4. To constrict leakage flow 8 through the leakage gap 18 a fluid flow 14 is injected through the nozzle opening 13 of the feed line 12 which is supplied by cooling air 10 which cools the platform 5 of the vane 4 by impingement cooling. Hereto an impingement sheet 21 is arranged within a cooling system inside the platform 5 of the vane 4.

FIG. 2b shows a longitudinal section through a blade 1 which provides a cooling channel 11 for cooling the air foil of the blade 1. Hereto cooling air 10 enters the cooling channel 11 at the foot section of the blade 1. Close before emanating into the main flow path of the flow machine at the rear edge 22 of the blade 1 a portion of the cooling air 10 enters a feed line 12 for injecting as a fluid flow 14 through the nozzle opening 13 into the leakage gap 18 bordered by the platforms 2 and 5 of the blade 1 and the vane 4. The fluid flow 14 constricts the leakage flow 8 significantly.

FIG. 2c shows a longitudinal section through a part of an airfoil of a blade 1 including a cooling channel 11. At the tip 23 of the blade 1 a nozzle opening 13 is provided through which a portion of cooling air 10 is injected as the fluid flow 14 into the leakage gap 18 bordered by the tip 23 of the blade 1 and a stationary component 17, for example a heat shield element.

1. Fluid seal arrangement for constricting a leakage flow directed through a leakage gap bordered by a rotational and a stationary component comprising at least one nozzle opening in the rotating and/or stationary component facing towards the rotating or stationary component of an opposite side of the leakage gap respectively in order for injecting a liquid or gaseous fluid flow through the nozzle opening into the leakage gap, wherein said at least one nozzle opening is fluidly connected to a cooling channel inside said rotating and/or stationary component, so that said fluid flow emanating at the nozzle opening consists of a cooling fluid of the rotating and/or stationary component exclusively.

2. Fluid seal arrangement according claim 1, wherein the at least one nozzle opening provides a nozzle axis along which the fluid flow is directed, and said nozzle axis is tilted relative to a radial direction of an axis of rotation of the rotational component such that a momentum of rotation of the rotating component is enhanced or decreased by the fluid flow emanating the at least one nozzle opening and impacting on the rotating or stationary component being opposite of the leakage gap to said nozzle opening.

3. Fluid seal arrangement according to claim 2, wherein the at least one opening is arranged at the stationary component with a nozzle axis including an angle α≠0° with a radial direction crossing the nozzle such that the nozzle axis is inclined in or opposite to the rotational of the rotational component and/or the at least one nozzle opening is arranged at the rotational component with a nozzle axis including an angle ≠0° with a radial direction crossing the nozzle opening such that the axis is inclined in or against the rotational direction of the rotational component.

4. Fluid seal arrangement according to claim 3, wherein for α and β shall apply: α is equal to β or α is unequal to β and
0°<α, β<±90°, preferably ±5°≦α, β≦±50°.

5. Rotational flow machine with a fluid seal arrangement according to claim 1, wherein the rotational flow machine is a compressor or a turbine stage in a gas turbine arrangement and the at least one rotational component is a blade or a section of a surface of a rotor and the at least one stationary component is a housing or a component connected to the housing directly or indirectly, preferably a vane, a heat shield element or a combustor liner.

6. Rotational flow machine according to claim 5, wherein the leakage gap is bordered by a tip of the blade providing said at least one nozzle opening and the housing or a component connected to the housing of the rotational flow machine, and the at least one nozzle opening is connected to a cooling channel inside the blade for cooling the blade and/or the leakage gap is bordered by a tip of the blade and the housing or a component connected to the housing of the rotational flow machine, whereby the housing or the component provides the at least one nozzle opening, and the at least one nozzle opening is connected to a cooling channel inside the housing or the component connected to the housing for cooling the housing or the component.

7. Rotational flow machine according to claim 5, wherein the leakage gap is bordered by a section of a radially inner platform of the blade and a section of a radially outer platform of a vane, and the at least one nozzle opening is at the blade's and/or vane's section side and connected to a cooling channel for cooling the blade or vane respectively.

8. Rotational flow machine according to claim 6, wherein the cooling channel is a convective cooling channel or includes an impingement cooling arrangement.

9. Method for constricting a leakage flow through a leakage gap bordered by at least one rotational and at least one stationary component by injecting a liquid or gaseous fluid flow into the leakage gap with a direction of flow being transversely to the direction of flow of the leakage flow, wherein the liquid or gaseous fluid flow serves as a cooling medium for cooling the rotational and/or a stationary component first before entering the leakage gap.

10. Method according to the claim 9, wherein the liquid or gaseous fluid flow is directed into the leakage gap such that a momentum of rotation of the rotational component is enhanced or reduced by an impact of the liquid or gaseous fluid flow with the rotational and/or stationary component.

11. Method according to claim 9, wherein the rotational and stationary components are part of a rotary flow machine like a compressor or a turbine stage of a gas turbine arrangement.
